(19) United States
(12) Patent Application Publication
(10) Pub. No.: US 2003/0090855 A1
(43) Pub. Date: May 15, 2003

(54) Over-current protection device and apparatus thereof

(76) Inventors: Edward Fu-Hua Chu, Taipei (TW); David Shau-Chew Wang, Taipei (TW); Yun-Ching Ma, Pingtung City (TW)

Correspondence Address: Harold V. Stotland, Seyfarth Shaw, 42nd Floor, 55 East Monroe Street, Chicago, IL, 60603-5803, US

(21) Appl. No.: 10/292,305

(22) Filed: Nov. 12, 2002

(30) Foreign Application Priority Data
Nov. 12, 2001 (TW) 090219410

(51) Int. Cl. H01G 4/008

(52) U.S. Cl. 361/305

(57) ABSTRACT

The present invention discloses an over-current protection device and the apparatus thereof. The over-current protection device includes a first electrode foil, a second electrode foil and a plurality of polymer current-sensing elements, wherein the plurality of polymer current-sensing elements are formed by stacking and electrical connection in series. The first and second electrode foils are disposed on the corresponding surface of the plurality of polymer current-sensing elements, and the difference in the transition temperature between adjacent polymer current-sensing elements is at least 5° C.

### BACKGROUND OF THE INVENTION

1. Field of the Invention

The invention relates to an over-current protection device and the apparatus and their manufacturing method, especially to an over-current protection device and apparatus including various conductive composite materials with positive temperature coefficient connected in series and their manufacturing method.

2. Description of Related Art

For the present broad application of portable electronic products, such as mobile phone, notebook, portable camera, personal digital assistant (PDA), etc., the importance of using over-current protection device to prevent the short circuit caused by an over-current or over-heating effect in a secondary battery or circuit device is becoming more and more inevitable.

The prior over-current protection device 10 includes a first electrode foil 12, a second electrode foil 13 and a current-sensing element 11, as shown in FIG. 1a. If the over-current protection device 10 is used to protect the secondary battery, the surfaces of the first and second electrode foils 12 and 13 will be respectively connected with metal conductive strips to serve as the conducting leads for electrically connecting to the positive and negative terminations of the secondary battery.

At present, a general current-sensing element 11 is formed by the conductive material with positive temperature coefficient (PTC), which comprises a polymer and a conductive filler. Since the resistance value of the PTC conductive material is sensitive to the temperature variation, during normal operation, the resistance can remain extremely low so as to make the circuit operate normally. However, when the temperature rises due to an over-current or over-heating phenomenon, the resistance value will increase to a high resistance state (e.g. above 10⁴ ohm) instantaneously, which will drastically limit the excess current so as to achieve the purpose of protecting the battery or circuit devices.

Traditionally, an over-current protection device can be manufactured by extrusion lamination as shown in FIG. 1b. The PTC conductive material 15 contained in a reservoir 14 is heated to flow easily. An upper roller 16 and a lower roller 17 rotate in opposite directions respectively, and pull a first electrode foil 161, a second electrode foil 171 and the PTC conductive material 15 extruded through a nozzle 18 by a pusher 19 to form a laminate constituted of the first electrode foil 161, a polymer current-sensing element 151 and the second electrode toil 171. Sequentially, the polymer current-sensing element 151 is cured, for example, by Cobalt 60 irradiation.

Generally, one of the reasons that the PTC over-current protection device can protect the battery or circuit devices is the abrupt increase in resistance value at the transition temperature. The higher the peak resistance value is, the higher voltage endurance of the over-current protection device is when the temperature of the PTC over-current protection device is higher than the transition temperature (Ts). What is called the trip reaction is when the temperature of the current-sensing element rises due to the over-current phenomenon; the difference shown as the resistance instantly rises from a low resistance state (i.e. initial resistance value Rₘᵢₙ) to a high resistance state (i.e. peak resistance value Rₚₑₐₖ). The greater difference means the higher trip ratio (Rₚₑₐₖ/Rₘᵢₙ), and the transition temperature means the temperature at which the resistance value of the PTC over-current protection device increases to be over 100 times of the resistance value under normal temperature.

Furthermore, the power dissipation Pd of the over-current protection device can be expressed by the following general formula: Pd=V²/R, wherein V is the endurable voltage, and R is the peak resistance value. It should be understood from the above general formula that the higher the peak resistance value is, the greater the trip ratio is, and also the higher the endurable voltage relatively is.

The prior method used to increase the peak resistance value of the over-current protection device is to reduce the content of the conductive filler (e.g. carbon black). However, such method will increase the initial resistance value relatively, and reduce the conductivity. Therefore, the invention provides a novel over-current protection device which can endure high voltage for resolving such a problem.

### SUMMARY OF THE INVENTION

The major object of the invention is to provide an over-current protection device and the apparatus thereof, which stacks two or more current-sensing elements with different resistance values and thicknesses in series, so as to reduce the initial resistance value and increase the peak resistance value for increasing the endurable voltage.

The second object of the invention is to provide an over-current protection device and the apparatus thereof, wherein the resistance value can be changed by connecting different current-sensing elements in series to meet the voltage endurance requirement.

The third object of the invention is to provide an over-current protection device and the apparatus thereof, wherein the variation of the resistance value to the temperature can be made to meet the requirement of temperature and resistance by controlling the transition temperature of each current-sensing element connected in series.

To achieve above-mentioned objects and to avoid the drawback of the prior art, the invention discloses an over-current protection device and the apparatus thereof. The over-current protection device includes a first electrode foil, a second electrode foil and a plurality of polymer current-sensing elements, wherein the plurality of polymer current-sensing elements are formed by stacking and electrical connection in series. The first and second electrode foils are disposed on the corresponding surface of the plurality of polymer current-sensing elements, and the difference in transition temperature between adjacent polymer current-sensing elements is at least 5° C.

The invention includes at least two kinds of current-sensing elements to form a structure connected in series. The structure can be formed by lamination or a conductive link material, such as a conductive silver glue or metal foil and the like. Each current-sensing element may be provided with a different thickness, resistance value, transition temperature and curing exposure dosage. Thus, the requirement of the PTC over-current protection device for the resistance value, endurable voltage, and temperature may be varied by controlling the thickness, resistance value, transition temperature and curing exposure dosage of each current-sensing element. The over-current protection apparatus of the invention includes a plurality of the over-current protection devices, a first connection portion, a second connection portion and at least one insulation layer. The first connection portion includes a first outer conductive member and a first conductive hole, which is used to electrically connect the first electrode foil of the plurality of over-current protection devices and the first outer conductive member. The second connection portion includes a second outer conductive member and a second conductive hole, which is used to electrically connect the second electrode foil of the plurality of over-current protection devices and the second outer conductive member. The insulation layer is used to isolate the adjacent over-current protection devices and also to isolate the over-current protection device with the first and second outer conductive members. Such design of the over-current protection device and apparatus can be used for mounting on a circuit board.

The over-current protection device can be manufactured by extrusion in accordance with the following steps: (1) forming a first laminate of a first electrode foil and a first current-sensing element by extrusion; (2) combining a second current-sensing element and a second electrode foil to the first laminate by extrusion to generate a second laminate of the first electrode foil, the first current-sensing element, the second current-sensing element and the second electrode foil, the first current-sensing element and the second current-sensing element being in series and the difference of transition temperature of them being at least 5° C.; and (3) cutting the second laminate to form the over-current protection device.

Furthermore, the over-current protection device can be manufactured by co-extrusion, which comprises the steps: (1) extruding a plurality of current-sensing elements; (2) combining a first electrode foil and a second electrode foil to the plurality of current-sensing elements to form a laminate, the difference of transition temperature between two adjacent current-sensing elements is at least 5° C.; and (3) cutting the laminate to form the over-current protection device.

### BRIEF DESCRIPTION OF THE DRAWINGS

The present invention will be described according to the appended drawings in which:

FIG. 1a shows a cross-sectional diagram of a prior art over-current protection device;

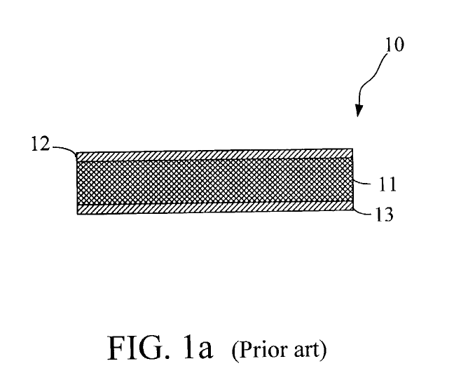

FIG. 1b shows a known manufacturing method of an over-current protective device;

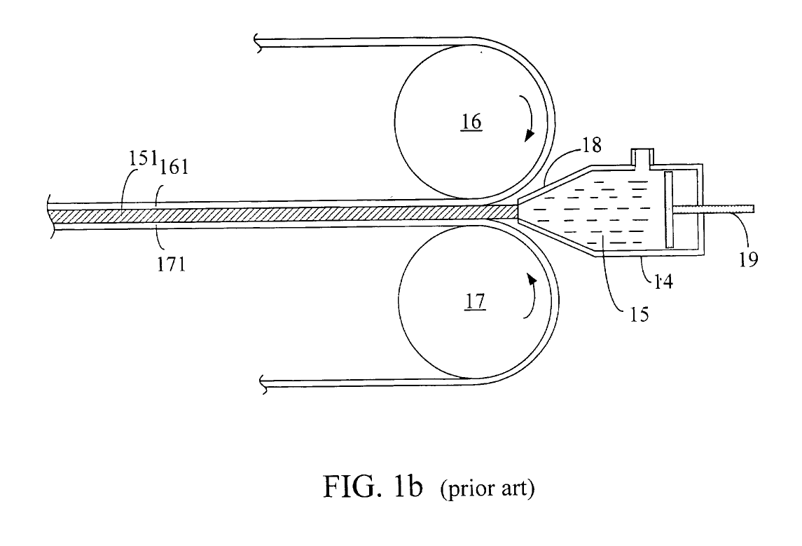

FIG. 2 shows a cross-sectional diagram of the over-current protection device of a first embodiment according to the invention;

FIG. 3 shows resistance-temperature curves of the over-current protection devices of the invention and of the prior device;

FIG. 4 shows a cross-sectional diagram of the over-current protection device of a second embodiment according to the invention;

FIG. 5 shows a cross-sectional diagram ol the over-current protection device of a third embodiment according to the invention;

FIG. 6 shows a cross-sectional diagram of the over-current protection apparatus of the first embodiment according to the invention;

FIG. 7a, 7b, 7c show the manufacturing methods of the over-current protection of the present invention;

FIG. 8 shows a cross-sectional diagram of the over-current protection device of the fourth embodiment according to the invention; and

FIG. 9 shows a cross-sectional diagram of the over-current protection device of the fifth embodiment according to the invention.

### DESCRIPTION OF PREFERRED EMBODIMENTS

The invention discloses an over-current protection device including at least two kinds of current-sensing elements, of which transition temperatures (Ts) differ by at least 5° C. The invention stacks the current-sensing elements in series so that the peak resistance value may be varied according to the voltage endurance requirement.

The initial resistance value Rₘᵢₙ and the peak resistance value Rₚₑₐₖ of the present invention can be expressed by the following equations:

Rₘᵢₙ=R1ₘᵢₙ×(t₁/t₀)+R2ₘᵢₙ×(t₂/t₀)+R3ₘᵢₙ×(t₃/t₀)+ . . . +Riₘᵢₙ×(t₁/t₀) (1)

Rₚₑₐₖ=R1ₚₑₐₖ×(t₁/t₀)+R2ₚₑₐₖ×(t₂/t₀)+R3ₚₑₐₖ×(t₃/t₀)+ . . . +Riₚₑₐₖ×(t₃/t₀) (2)

where R1ₘᵢₙ, R2ₘᵢₙ, R3ₘᵢₙ . . . Riₘᵢₙ represent the initial resistance values of the first, second, third to the i^{th} current-sensing element with thickness t₀, respectively; R1ₚₑₐₖ, R2ₚₑₐₖ, R3ₚₑₐₖ . . . Riₚₑₐₖ represent the peak resistance values of the first, second, third to the i^{th} current-sensing element with thickness t₀, respectively; t₁, t₂, t₃ . . . t₁ represent the thicknesses of the first, +second, third to the i^{th} current-sensing element, respectively; t₀=t₁+t₂+t₃+ . . . +t₁₀

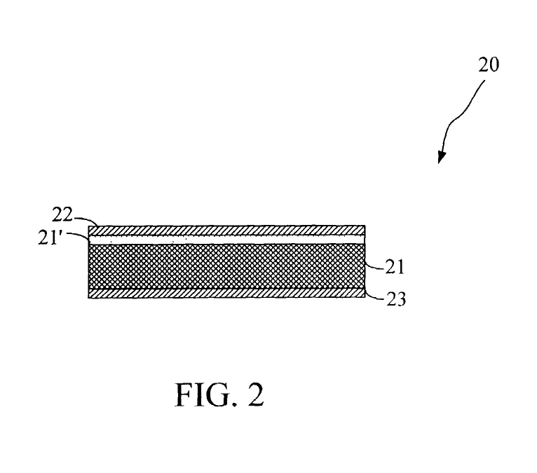

FIG. 2 shows the cross-sectional view of the over-current protection device 20 of the first embodiment according to the invention. The over-current protection device 20 includes a first current-sensing element 21, a second current-sensing element 21′, a first electrode foil 23 and a second electrode foil 22. The first electrode foil 23 is disposed on the surface of the first current-sensing element 21 opposite to the second current-sensing element 21′, and the second electrode foil 22 is disposed on the surface of the second current-sensing element 21′ opposite to the first current-sensing element 21. The first electrode foil 23 and the second electrode foil 22 are made of a metal conductive material, such as Cu, Ni, Pt, Au and their alloy thereof.

Both the first current-sensing element 21 and the second current-sensing element 21′ are formed of the conductive composite material with positive temperature coefficient. The first current-sensing element 21 includes a first polymer and a first conductive filler, and the second current-sensing element 21′ includes a second polymer and a second conductive filler. The first polymer and the second polymer may be the same or different polymers, such as polyolefin polymer, epoxy resin, etc. Also, the first conductive filler and the second conductive filler may also be the same or different conductive fillers, such as carbon black, metal powder, ceramic powder, etc. The transition temperature Ts1 of the first current-sensing element 21 may be set as above 60° C., and the transition temperature Ts2 of the second current-sensing element 21′ differs from the first current-sensing element 21 by at least 5° C.(|Ts2−Ts1|>5° C.).

Furthermore, the volumetric resistance value of the first current-sensing element 21 of the over-current protection device 20 in the invention is lower than that of the second current-sensing element 21′ by at least 10%. And the ratio of the thickness of the second current-sensing element 21′ to that of the first current-sensing element 21 is between 0.01-0.96.

In the over-current protection device 20 of the first embodiment of the invention, if the unit volumetric resistance value of the first current-sensing element 21 is 1.43 Ω-cm, while the thickness is t₀ (e.g. about 0.21 mm), the initial resistance value R1ₘᵢₙ is 50 mΩ and the peak resistance value R1ₚₑₐₖ is 100Ω. If the unit volumetric resistance value of the second current-sensing element 21′ is 3.14 Ω-cm, while the thickness is t₀, the initial resistance value R2ₘᵢₙ is 110 mΩ and the peak resistance value R2ₚₑₐₖ is 100,000Ω. When the current-sensing elements 21 and 21′ is combined in series and the total thickness is controlled to remain at t₀, and the ratio of the thickness of the first current-sensing element 21 to that of the second current-sensing element 21′ is 9:1, because the resistance of the current-sensing element is proportional to its thickness, according to the calculation from equations (1) and (2), the initial resistance value of the formed over-current protection device is 56 mΩ (Rₘᵢₙ=50 mΩ×0.9+110 mΩ×0.1=56 mΩ), and the peak resistance value is 10090Ω (Rₚₑₐₖ=100Ω×0.9+100,000Ω×0.1=10090Ω). Based on the above description, the over-current protection device 20 of the invention will exhibit an overall initial resistance close to the lowest initial resistance of the first current-sensing element 21, while its overall peak resistance value will increase to the level close to the highest peak resistance of the second current-sensing element 21′. Therefore, the device 20 could achieve a high peak resistance value without sacrificing its low initial resistance value.

The peak resistance at the transition temperature of the plurality PTC laminated structure could be controlled by the resistance contribution not only from each PTC layers, but also from the interface between the two PTC layers. Since the interface is affected by two different thermal expansion coefficients PTC materials on each side, the resistance at the interfacial region could drastically increase to a very high value while the PTC materials are rapidly thermal expanded in the transition state. With careful construction of the interface, one could take advantage of the interfacial resistance contribution to obtain an exceedingly high peak resistance from the multi-layer structure of this invention.

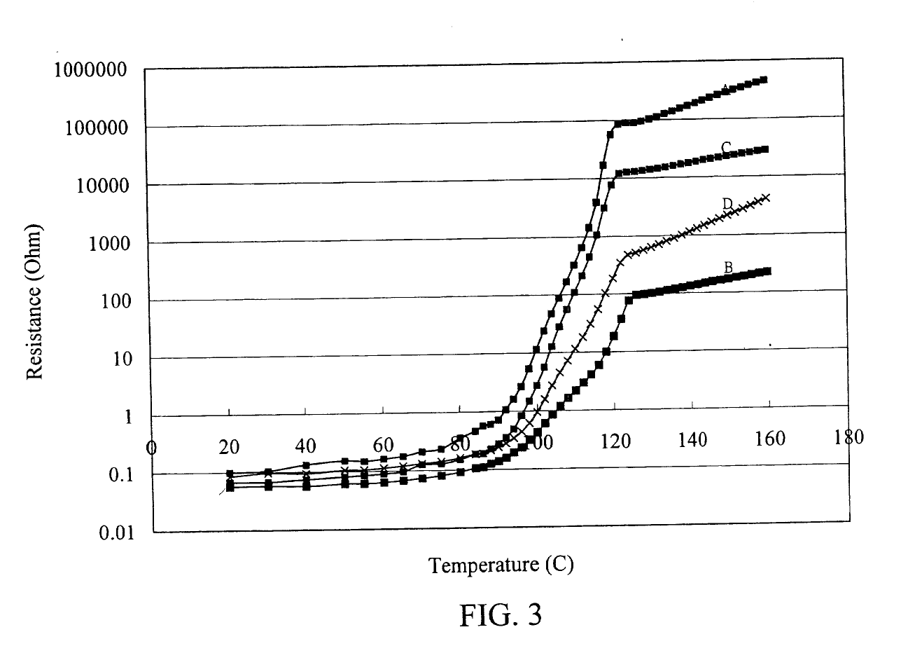

FIG. 3 shows the resistance-temperature curves of the over-current protection device of the invention and of the prior device. A curve A represents the prior over-current protection device with single current-sensing element, which is formed by the PTC conductive composite material with high resistance (the initial resistance value is 110 mΩ, and the peak resistance value is 100,0000Ω. A curve B represents another prior over-current protection device with single current-sensing element, which is formed by the PTC conductive composite material with low resistance (the initial resistance value is 50 mΩ, and the peak resistance value is 100Ω). A curve C represents the over-current protection device with double layers of the current-sensing elements of one embodiment according to the invention, wherein the double layers of the current-sensing elements are formed by stacking the PTC conductive composite material with high resistance (in 10% of the total thickness) and with low resistance (in 90% of the total thickness). A curve D represents another prior over-current protection device with single current-sensing element, but the current-sensing element is formed by melt mixing the high resistance PTC conductive composite material (10% in volume) with the low resistance PTC conductive composite material (90% in volume).

As shown in FIG. 3, the over-current protection device of the invention not only can reduce the initial resistance value of the conductive composite material with high resistance, but also can increase the peak resistance value and cut-off speed (for temperature sensitivity) of the conductive composite material with low resistance. Furthermore, by comparing curve C with curve D, the peak resistance value and cut-off speed of the double layers of current-sensing elements in the invention are higher than those of the single current-sensing element formed by directly mixing the conductive composite material with high resistance and the conductive composite material with low resistance. Since curve C exhibits higher peak resistance than curve D, it is expected that curve C should have much better voltage endurance than curve D. The curve C shows a lower transition temperature in comparison with curve D. The lower transition temperature characteristics indicate the better low temperature sensitivity of the device.

Further, the structure of the over-current protection device of the invention not only can be formed by lamination, but also can be formed by a conductive tie-layer material with high conductivity, such as conductive silver glue or metal foil so as to electrically connect the two adjacent polymer current-sensing elements.

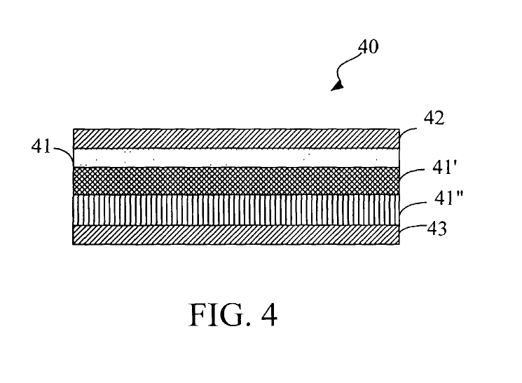

FIG. 4 shows the cross-sectional view of the over-current protection device 40 of the second embodiment according to the invention. The over-current protection device 40 includes a first current-sensing element 41, a second current-sensing element 41′, a third current-sensing element 41″, a first electrode foil 43 and a second electrode foil 42, wherein the transition temperature Ts1 of the first current-sensing element 41 can be set above 60° C., the transition temperature Ts2 of the second current-sensing element 41′ differs from that of the first current-sensing element 41 by at least 5° C. (|Ts2−Ts1|>5° C.), and the transition temperature Ts3 of the third current-sensing element 41″ differs from that of the second current-sensing element 41′ by at least 5° C.(|Ts3−Ts2|>5° C.). The second electrode foil 42 is disposed on the surface of the first current-sensing element 41 opposite to the second current-sensing element 41′, and the first electrode foil 43 is disposed on the surface of the third current-sensing element 41″ opposite to the second current-sensing element 41′.

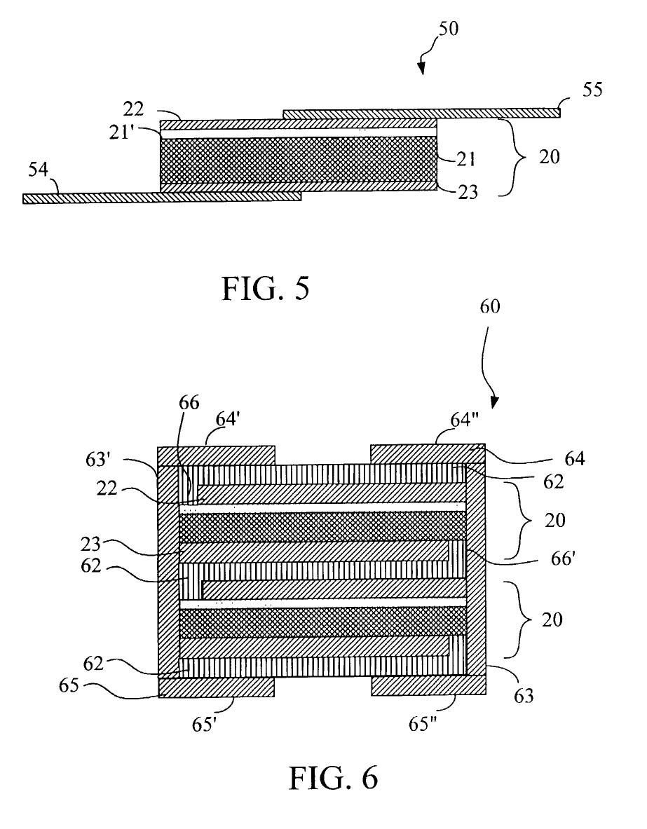

The over-current protection device of the invention not only can be used for protecting the secondary battery, but also can be mounted on the circuit board to protect the circuit devices. While the over-current protection device of the invention is used for protecting the secondary battery, it may further include a first conductive member 54 and a second conductive member 55, which are disposed on the surfaces of the said first electrode foil 23 and the second electrode foil 22 opposite to the current-sensing elements 21 and 21′ respectively. As shown in FIG. 5, the configuration directions of the first conductive member 54 and the second conductive member 55 are of the same direction or are opposite to each other, and the first conductive member 54 and the second conductive member 55 are metal conductive sheets or conductive wires so as to electrically connect to the positive/negative poles of the secondary battery or be directly inserted onto the circuit board.

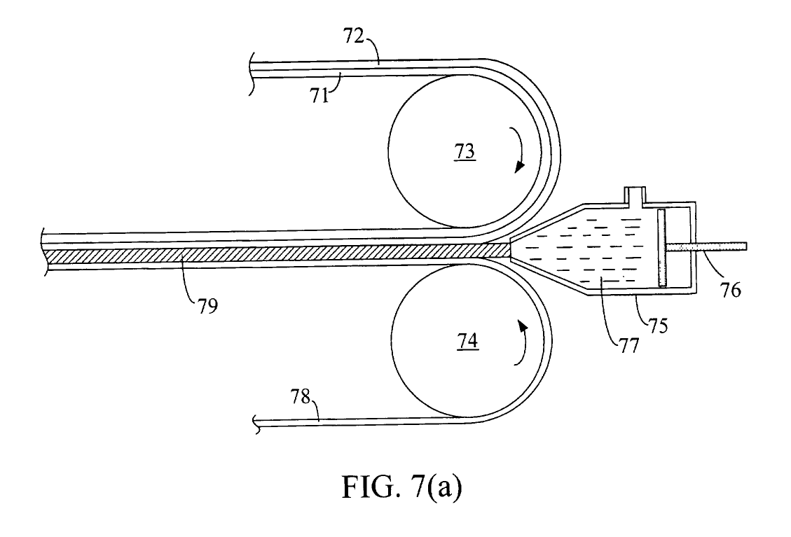

Besides, the invention can connect a plurality of over-current protection device 20 in parallel with a first connection portion 63 and a second connection portion 63′ to form an over-current protection apparatus 60. The first connection portion 63 includes a first outer conductive member 64 and a first conductive hole (not shown). The first conductive hole is used to electrically connect the first electrode foil 23 of the plurality of over-current protection devices 20 and the first outer conductive member 64. The second connection portion includes a second outer conductive member 65 and a second conductive hole (not shown) used to electrically connect the second electrode foil 22 of the plurality of over-current protection devices and the second outer conductive member 65, as shown in FIG. 6. One end of the first electrode foil 23 of each over-current protection device 20 forms a first insulation region 66′ by etching, and one end of the second electrode foil 22 opposite to the insulation region 66′ forms a second insulation region 66 also by etching. The over-current protection device after connecting parallelly further includes at least one insulation layer 62. The outer conductive members 64 and 65 can form two conductive ends 64′, 64″ and 65′, 65″ by etching. Furthermore, insulation layers 62 are used as barrier layers between the adjacent electrode foils and between the electrode foil and the outer conductive member. The electrode foils are electrically connected to the circuit devices of the external circuit board (not shown) by the conductive ends 64′, 64″ and 65′, 65″ for protecting the circuit devices.

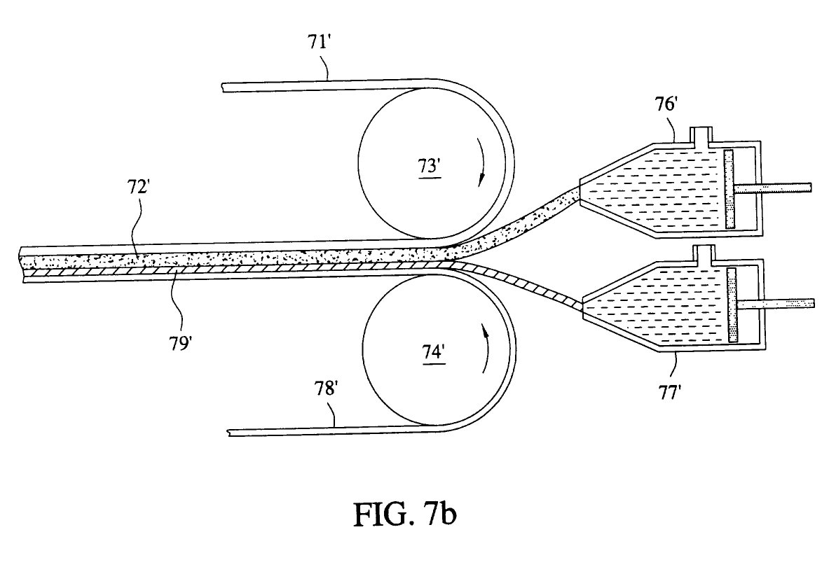

The manufacturing methods of the over-current protection device having two polymer current-sensing elements in accordance with the present invention are shown in FIG. 7a, 7b, and 7c. In FIG. 7a, a first laminate comprising a single polymer current-sensing element is fabricated in accordance with the process mentioned above, and then one electrode foil of the first laminate is removed so that only a first electrode foil 71 and a first polymer current-sensing element 72 are left. Similarly, both the first electrode foil 71 and the polymer current-sensing element 72 are pulled by an upper roller 73 to combine with the PTC conductive material 77 extruded from a reservoir 75 by a pusher 76 and a second electrode foil 78 pulled by a lower roller 74 to form a second laminate. The second laminate comprises the first electrode foil 71, the first polymer current-sensing element 72, a second polymer current-sensing element 79 and the second electrode foil 78, and then the second laminate is cut to form the over-current protection device.

The process could be further improved to the multi-layer co-extrusion process in combination with lamination process. As shown in FIG. 7b, two polymer current-sensing elements 72′ and 79′ are extruded out from two extruders means 76′ and 77′, respectively. Both extrudates are laminated with a first electrode foil 71′ and a second electrode foil 78′ respectively pulled by rollers 73′, 74′ to form an over-current protection laminate. This over-current protection laminate comprises the first electrode foil 71′, the first polymer current-sensing element 72′, the second polymer current-sensing element 79′, and the second electrode foil 78′. This process allows us to prepare multi-layer PTC laminate by extrusion of multiple PTC conductive materials from multiple extruders.

Another embodiment of PTC multi-layer co-extrusion process is shown in FIG. 7c. With splitting die design, two current-sensing elements 72″, split from extruder means 76″, are laminated with a first electrode foil 71″ and a second electrode foil 78″ pulled by rollers 73″, 74″, and a second current-sensing element 79″ extruded from extruder means 77″ to form an over-current protection laminate, which comprises the first electrode foil 71″, two first polymer current-sensing elements 72″, the second polymer current-sensing element 79″, and the second electrode foil 78″, in which the second polymer current-sensing element 79″ is between the two first polymer current-sensing elements 72″.

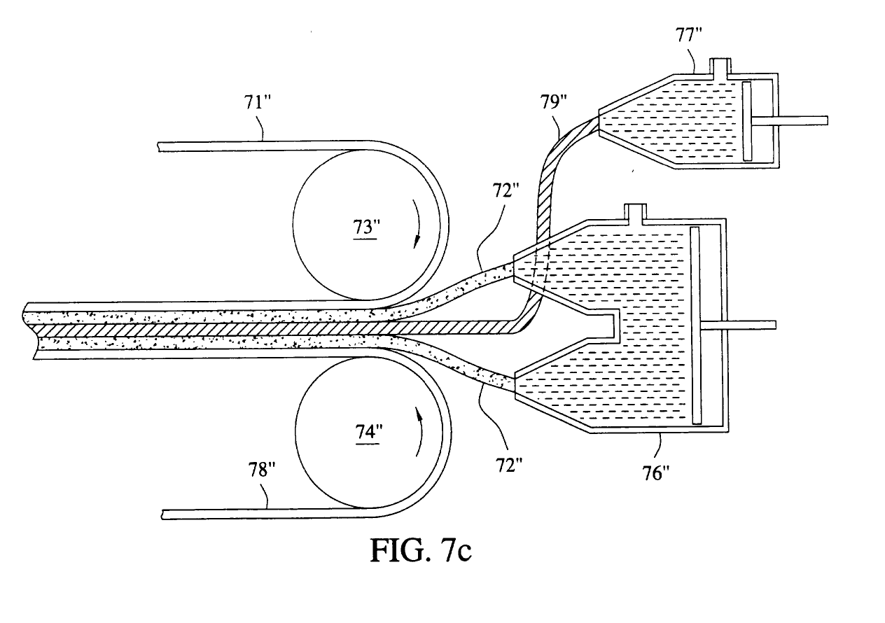

As shown in FIG. 8, the above mentioned laminates can be subsequently cut to obtain an over-current protection device 80 of the embodiment of the present invention, which comprises a first electrode foil 81, a first polymer current-sensing element 82, a second polymer current-sensing element 83 and a second electrode foil 84, where the difference between the transitional temperatures of the first polymer current-sensing element 82 and the second polymer current-sensing element 83 is at least 5° C. to gain the benefits mentioned above. Firstly, the first polymer current-sensing element 82 is in exposure of Cobalt 60 with lower dosage such as 1 Mrad (million roentgen-absorbed dose) to increase hardness thereof by crosslink of PTC conductive material before the second lamination process. After the second lamination, the first polymer current-sensing element 82 and the second polymer current-sensing element 83 are exposed to a normal dosage irradiation, e.g., 10 Mrads, and thus the accumulated exposure dosages of the first polymer current-sensing element 82 and the second polymer current-sensing element 83 are 11 Mrads and 10 Mrads, respectively. The different exposure dosages of the first polymer current-sensing element 82 and the second polymer current-sensing element 83 can be use to tune each layer's contribution to the overall device performance.

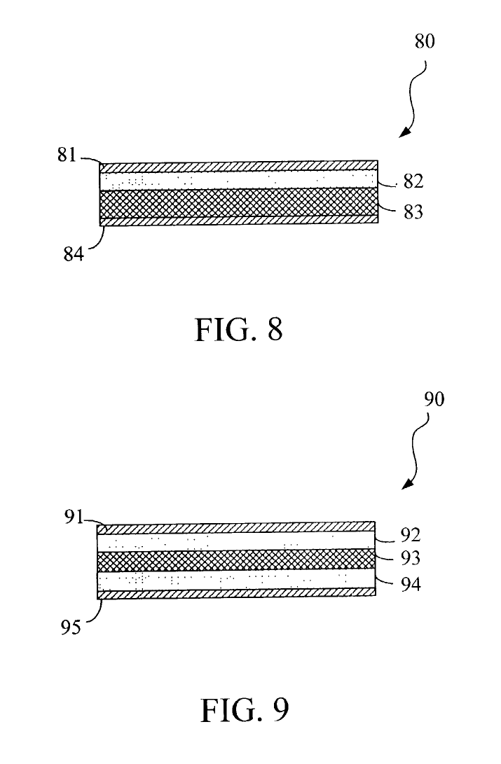

Referring to FIG. 9, the above process can be repeated to produce a tri-layer structure. A first polymer current-sensing element 92 and a second polymer current-sensing element 94 are combined with an first electrode foil 91 and a second electrode foil 95 respectively, and then a third polymer current-sensing element 93 is added between the first polymer current-sensing element 92 and the second polymer current-sensing element 94. Sequentially, all the first polymer current-sensing element 92 and the second polymer current-sensing element 94 are exposed to 1 Mrad γ-ray irradiation. After lamination with the third polymer current-sensing element 93, the whole multi-layer laminate is exposed to 10 Mrads γ-ray irradiation to form the over-current protection device 90. Thus, the over-current protection device 90 comprises the first electrode foil 91, the first polymer current-sensing element 92 exposed 11 Mrads, the third polymer current-sensing element 93 exposed 10 Mrads, the second polymer current-sensing element 94 exposed 11 Mrads, and the second electrode foil 95. Usually, the difference in the exposure dosage of adjacent polymer current-sensing elements is between 0.1 to 10 Mrads.

The use of exposure technique in addition to the control of the transition temperature can well overcome the interface issue of adjacent polymer current-sensing elements, and thus the superior quality of the over-current protection device and apparatus thereof can be obtained.

The above-described embodiments of the present invention are intended to be illustrative only. Numerous alternative embodiments may be devised by those skilled in the art without departing from the scope of the following claims.

What is claimed is:

1. An over-current protection device comprising a first electrode foil, a second electrode foil and a plurality of polymer current-sensing elements, wherein the plurality of polymer current-sensing elements are electrically connected in series and the difference of transition temperature between two adjacent polymer current-sensing elements is at least 5° C.

2. The over-current protection device of claim 1, wherein the transition temperature of the plurality of polymer current-sensing elements is above 60° C.

3. The over-current protection device of claim 1, wherein the first electrode foil and the second electrode foil are made of a conductive metal material.

4. The over-current protection device of claim 1, further comprising a conductive link material for electrically connecting two adjacent polymer current-sensing elements.

5. The over-current protection device of claim 4, wherein the conductive link material is a conductive silver glue or metal foil.

6. The over-current protection device of claim 1, wherein the polymer current-sensing element comprises a polymer and a conductive filler.

7. The over-current protection device of claim 1, wherein the difference in the volumetric resistance value between two adjacent polymer current-sensing elements is at least 10%.

8. The over-current protection device of claim 1, further comprising a first conductive member and a second conductive member disposed on the surfaces of the first electrode foil and the second electrode foil.

9. The over-current protection device of claim 8, wherein the first conductive member and the second conductive member are metal conductive sheets or conductive wires.

10. The over-current protection device of the claim 1, wherein the adjacent polymer current-sensing elements have different curing exposure dosages.

11. The over-current protection device of the claim 10, wherein the difference in the curing exposure dosage of the adjacent polymer current-sensing elements is between 0.1 to 10 Mrads.

12. The over-current protection device of the claim 1, wherein the polymer current-sensing elements are in exposure of Cobalt 60.

13. An over-current protection apparatus, comprising
at least one over-current protection device of claim 1;
a first connection portion, including:
(a) a first outer conductive member; and
(b) a first conductive hole for electrically connecting the first electrode foil of the at least one over-current protection device and the first outer conductive member;
a second connection portion, including:
(a) a second outer conductive member; and
(b) a second conductive hole for electrically connecting the second electrode foil of the at least one over-current protection device and the second outer conductive member; and
at least one insulation layer for insulating adjacent over-current protection devices and for insulating the over-current protection device from the first and second outer conductive members.

14. The over-current protection apparatus of claim 13, wherein the first and second connection portions are made of a conductive metal material.

15. The over-current protection apparatus of claim 13, wherein the adjacent polymer current-sensing elements of the over-current protection device have different curing exposure dosages.

16. A manufacturing method of an over-current protection device, comprising the steps of:
forming a first laminate of a first electrode foil and a first current-sensing element by extrusion;
combining a second current-sensing element and a second electrode foil to the first laminate by extrusion to generate a second laminate of the first electrode foil, the first current-sensing element, the second current-sensing element and the second electrode foil, the first current-sensing element and the second current-sensing element being in series and the difference of transition temperature of them being at least 5° C.; and
cutting the second laminate to form the over-current protection device.

17. The manufacturing method of an over-current protection device of claim 16, wherein the first and the second current-sensing elements are exposed to different dosages. .

18. A manufacturing method of an over-current protection device, comprising the steps of:
extruding a plurality of current-sensing elements;
combining a first electrode foil and a second electrode foil to the plurality of current-sensing elements to form a laminate, the difference of transition temperature between two adjacent current-sensing elements is at least 5° C.; and
cutting the laminate to form the over-current protection device.

19. The manufacturing method of an over-current protection device of claim 18, wherein the first and the second current-sensing elements are exposed to different dosages.

20. The manufacturing method of an over-current protection device of claim 18, wherein at lease two current-sensing elements are generated by a splitting die.
